(19) United States
(12) Patent Application Publication
(10) Pub. No.: US 2012/0079194 A1
(43) Pub. Date: Mar. 29, 2012

(54) METHOD OF TESTING DATA STORAGE DEVICES AND A GENDER THEREFOR

(76) Inventor: Jong-hwan Lim, Cheonan-si (KR)

(21) Appl. No.: 13/227,837

(22) Filed: Sep. 8, 2011

(30) Foreign Application Priority Data
Sep. 28, 2010 (KR) 10-2010-0093803

(51) Int. Cl. G06F 12/08

(52) U.S. Cl. 711/114; 711/E12.019

(57) ABSTRACT

A method of testing data storage devices, the method including virtualizing data storage spaces of N data storage devices to a single virtual storage space, wherein N is a natural number equal to or greater than two, and testing the N data storage devices by performing a testing sequence on the virtual storage space.

### CROSS-REFERENCE TO RELATED APPLICATION

This application claims priority under 35 U.S.C. §119 to Korean Patent Application No. 10-2010-0093803, filed on Sep. 28, 2010, in the Korean Intellectual Property Office, the disclosure of which is incorporated by reference herein in its entirety.

### BACKGROUND

1. Technical Field

The inventive concept relates to a method of testing data storage devices and a gender therefor, and more particularly, to a method of testing a plurality of data storage devices and a gender for interconnecting the plurality of data storage devices so that the plurality of data storage devices can be tested simultaneously.

2. Discussion of the Related Art

Various types of data storage devices, such as a hard disk drive (HDD) and a solid-state drive (SSD), are used to store a large amount of digital data. SSDs are distinguished from traditional HDDs, which are electromechanical devices containing spinning disks and movable read/write heads. SSDs, in contrast, use microchips which retain data in non-volatile memory chips and contain no moving parts. Such data storage devices are tested before delivery to ensure normal operation. However, the amount of time and labor involved in testing generally increases in proportion to the number of data storage devices to be tested.

### SUMMARY

An exemplary embodiment of the inventive concept provides a method of efficiently testing a plurality of data storage devices.

An exemplary embodiment of the inventive concept provides a gender that is used to effectuate the efficient testing of a plurality of data storage devices.

According to an exemplary embodiment of the inventive concept, there is provided a method of testing data storage devices, the method including virtualizing data storage spaces of N data storage devices to a single virtual storage space, wherein N is a natural number equal to or greater than two; and testing the N data storage devices by performing a testing sequence on the virtual storage space.

The N data storage devices may be configured as a redundant array of independent disks (RAID) and may be recognized by a tester, which performs the testing sequence, as a single virtual data storage device having the virtual storage space. Furthermore, the N data storage devices may be recognized by a tester, which performs the testing sequence, as a single virtual data storage device having the virtual storage space by using disk striping.

The virtual storage space may include a plurality of strips, and each of the plurality of strips may include N segments. Here, the N segments of each of the plurality of strips may each be mapped to a respective one of the data storage spaces of the N data storage devices.

The testing sequence may include a sequential access test performed on the virtual storage space, and, during the sequential access test, logically continuous test data may be divided into data segments of a first size and the data segments may be written to the N data storage devices in a round-robin fashion.

The data segments may include a first data segment and a second data segment, which are logically continuous with each other, and, while the first data segment is being written to one of the N data storage devices, the second data segment may be written to another one of the N data storage devices.

First and second periods of time for respectively writing logically continuous first and second data segments of the data segments to the N data storage devices in a round-robin fashion may partially overlap each other.

The testing sequence may include a random access test performed on the virtual storage space.

At least one of the N data storage devices may include a solid state drive (SSD).

At least one of the N data storage devices may include a plurality of memory modules included in a multi SSD. At least one of the plurality of memory modules may include at least one memory chip; and a memory controller for controlling the at least one memory chip. Furthermore, the multi SSD may include a connector, wherein the connector includes a plurality of data pin sets, each of the data pin sets for independently inputting data to and outputting data from a respective one of the plurality of memory modules; and a power pin set for supplying power to the plurality of memory modules.

The testing sequence may be performed simultaneously on at least two of the N data storage devices.

According to an exemplary embodiment of the inventive concept, there is provided an apparatus for testing data storage devices, the apparatus including a first interface for connecting the apparatus to N data storage devices, wherein N is a natural number equal to or greater than two and each of the data storage devices includes a data storage space; a module, which is connected to the first interface and virtualizes the data storage spaces of the N data storage devices to a single virtual storage space; and a second interface connected to the module and connected to a tester, wherein the tester tests the N data storage devices by performing a testing sequence on the virtual storage space.

The module may include a RAID controller.

According to an exemplary embodiment of the inventive concept, there is provided an apparatus for testing a first memory module having at least one first memory chip and a first memory controller for controlling the at least one first memory chip and a second memory module having at least one second memory chip and a second memory controller for controlling the at least one second memory chip, the apparatus including a RAID controller that configures the first memory module and the second memory module as a RAID to be recognized as a single virtual data storage device by a tester; a back-end interface, to which the first memory module and the second memory module are connected and through which the first memory module and the second memory modules are connected to the RAID controller; and a front-end interface, to which the tester is connected and through which the tester is connected to the RAID controller.

The back-end interface may be a low-insertion force (LIF) type connector including a first data pin set for inputting data to and outputting data from the first memory module; a second data pin set for inputting data to and outputting data from the second memory module; and a power pin set for supplying power to the first and second memory modules. Furthermore, the front-end interface may be a serial advanced technology attachment (SATA) interface.

The first memory module and the second memory module may be included in an SSD.

The apparatus may further include a controller board including the RAID controller, the front-end interface and the back-end interface, wherein the controller board includes wiring for electrically connecting the RAID controller to the back-end interface and the front-end interface; and a supporting base, to which the controller board is attached and the SSD is detachably mounted.

According to an exemplary embodiment of the inventive concept, there is provided a method of testing data storage devices, the method including configuring a first data storage device and a second data storage device to be recognized, by a test device, as a single data storage device; and receiving, from the test device, first write data at a first data source of the first data storage device and second write data at a second data source of the second data storage device, wherein a time period during which the first write data is received overlaps with a time period during which the second write data is received.

### BRIEF DESCRIPTION OF THE DRAWINGS

The above and other features of the inventive concept will become more apparent by describing in detail exemplary embodiments thereof with reference to the accompanying drawings in which:

FIG. 1 is a diagram of a testing system for testing a plurality of data storage devices, according to an exemplary embodiment of the inventive concept;

FIG. 2 is a diagram showing a relationship between storage spaces of data storage devices and a virtual storage space, according to an exemplary embodiment of the inventive concept;

FIGS. 3A through 3C are diagrams for describing a sequential access test that may be performed by a tester, according to an exemplary embodiment of the inventive concept;

FIG. 4 is a view of a gender according to an exemplary embodiment of the inventive concept;

FIG. 5 is a diagram showing a multi solid state drive (SSD), which is a data storage device that may be connected to a gender according to an exemplary embodiment of the inventive concept; and

FIG. 6 is a perspective view of a gender according to an exemplary embodiment of the inventive concept, which may be connected to a multi SSD.

### DETAILED DESCRIPTION OF THE EMBODIMENTS

Exemplary embodiments of the inventive concept will be described more fully hereinafter with reference to the accompanying drawings. The inventive concept may, however, be embodied in many different forms and should not be construed as being limited to the exemplary embodiments set forth herein.

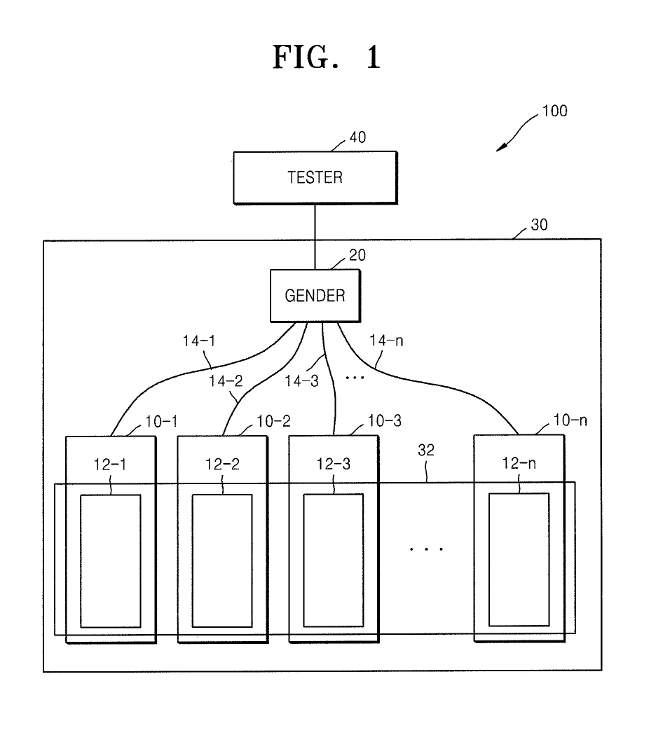

FIG. 1 is a diagram of a testing system 100 for testing a plurality of data storage devices 10-1 through 10-n, according to an exemplary embodiment of the inventive concept.

Referring to FIG. 1, the testing system 100 for testing the data storage devices 10-1 through 10-n includes a tester 40 and a gender 20. The data storage devices 10-1 through 10-n are connected to the tester 40 via the gender 20.

The data storage devices 10-1 through 10-n are tested before delivery. For example, before they are delivered from the manufacturer to a customer. FIG. 1 shows that the number of the data storage devices 10-1 through 10-n is N. Here, N is a natural number equal to or greater than 2, and the maximum value of N may be determined based on the performance of the data storage devices 10-1 through 10-n and input/output speeds of the data storage devices 10-1 through 10-n.

Some of the data storage devices 10-1 through 10-n may be magnetic-recording type hard disk drives (HDDs) or solid-state drives (SSDs) that use non-volatile semiconductor memories. Furthermore, the data storage devices 10-1 through 10-n may include a plurality of memory modules included in a multi-SSD. Each of the memory modules may include at least one memory chip and a memory controller for controlling the at least one memory chip. In addition, the memory modules may independently store digital data.

The data storage devices 10-1 through 10-n may be attached to a general-purpose computer, such as a personal computer (PC), a laptop computer, or a server, via a standard interface. The standard interface may be a serial advanced technology attachment (SATA) interface, an enhanced integrated drive electronics (E-IDE) interface, a small computer system interface (SCSI), a zero insertion force (ZIF) type interface, a compact flash (CF) type interface, a universal serial bus (USB) interface, IEEE 1394 interface, or the like. Alternatively, the data storage devices 10-1 through 10-n may be attached to a general-purpose computer via an exclusive-type interface, such as one defined by the manufacturer of the data storage devices 10-1 through 10-n. In FIG. 1, the data storage devices 10-1 through 10-n are connected to the gender 20 via input/output (I/O) interfaces 14-1 through 14-n, respectively.

The data storage devices 10-1 through 10-n may be data storage devices of the same type. However, it is not necessary for all of the data storage devices 10-1 through 10-n to be of the same type, and some of the data storage devices 10-1 through 10-n may be of different types.

The data storage devices 10-1 through 10-n include storage spaces 12-1 through 12-n for storing digital data, respectively. The storage spaces 12-1 through 12-n are logical spaces corresponding to a storage medium or a memory chip, in which digital data is physically stored. The storage spaces 12-1 through 12-n may have the same capacity. However, it is not necessary for all of the storage spaces 12-1 through 12-n to have the same capacity.

The tester 40 may perform a testing sequence for testing the data storage devices 10-1 through 10-n. The tester 40 may be a general-purpose computer, such as a PC, a laptop computer, or a server.

The tester 40 may be connected to the gender 20 via a standard interface. The standard interface may be a SATA interface, an E-IDE interface, an SCSI, a ZIF type interface, a CF type interface, a USB interface, an IEEE 1394 interface, or the like.

The gender 20 physically connects the data storage devices 10-1 through 10-n to the tester 40. Data is input and output between the tester 40 and the data storage devices 10-1 through 10-n via the gender 20. Furthermore, the gender 20 logically virtualizes the storage spaces 12-1 through 12-n of the data storage devices 10-1 through 10-n to a single virtual storage space 32 and makes the tester 40 recognizes that a single virtual data storage device 30 having the single virtual storage space 32 is connected to the tester 40.

The gender 20 may include a redundant array of independent disks (RAID) controller chip. In this case, the data storage devices 10-1 through 10-n may be configured as a RAID. More particularly, the data storage devices 10-1 through 10-n may be configured as a RAID 0 architecture using disk striping. Disk striping is a technique for writing logically continuous data, such as a single file, to a plurality of data storage devices in a round-robin fashion, for example.

In this case, the gender 20 corresponds portions of the virtual storage space 32 to the storage spaces 12-1 through 12-n of the data storage devices 10-1 through 10-n. The virtual storage space 32 may be divided into segments of a predetermined size, and the segments are mapped to the storage spaces 12-1 through 12-n of the data storage devices 10-1 through 10-n. A relationship between the storage spaces 12-1 through 12-n of the data storage devices 10-1 through 10-n and the virtual storage space 32 will be described below in detail with reference to FIG. 2.

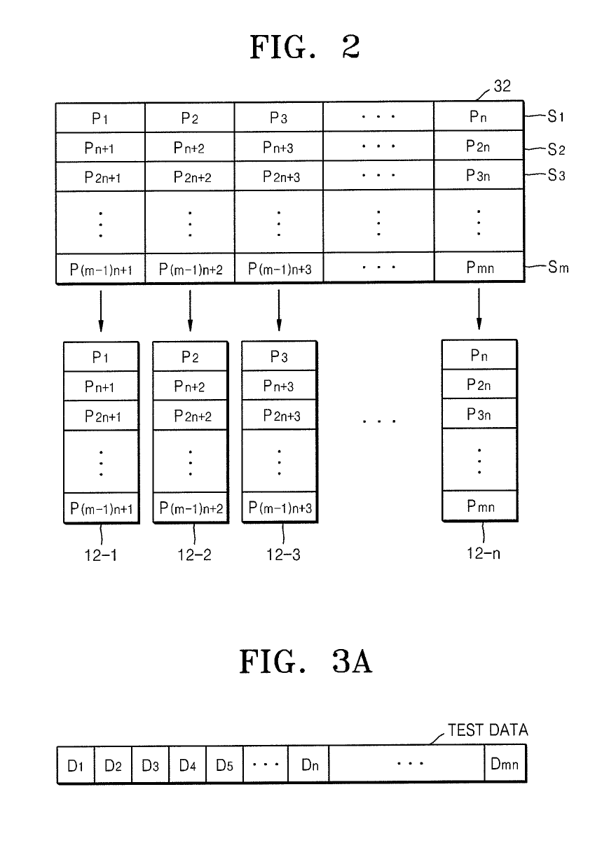

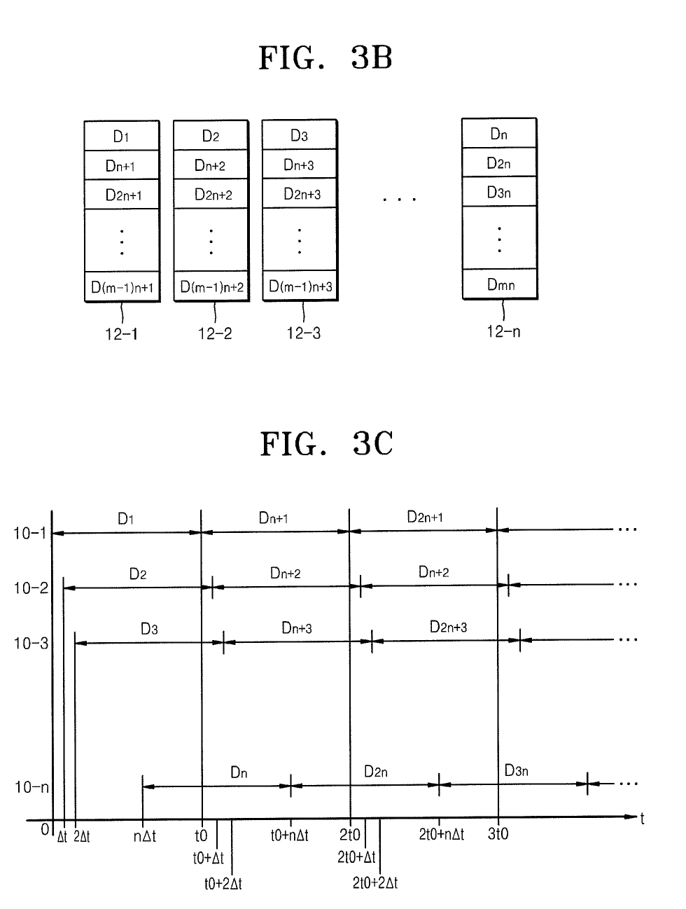

The data storage devices 10-1 through 10-n may be simultaneously tested when the tester 40 performs a testing sequence on the virtual storage space 32. Generally, data input and output between the tester 40 and the data storage devices 10-1 through 10-n is faster than writing/reading data to/from each of the data storage devices 10-1 through 10-n, and thus, the difference between a period of time elapsed for the tester 40 to test the single virtual data storage device 30 and a period of time for the tester 40 to test a single data storage device is insignificant. A detailed description thereof will be given below with reference to FIGS. 3A to 3C.

Furthermore, since the tester 40 performs a single testing sequence with respect to the virtual data storage device 30 instead of performing a plurality of testing sequences for each of the plurality of data storage devices 10-1 through 10-n, a conventional method, which is used to test data storage devices one at a time, may be used in accordance with an exemplary embodiment of the inventive concept, without being significantly modifying.

FIG. 2 is a diagram showing a relationship between the storage spaces 12-1 through 12-n of the data storage devices 10-1 through 10-n and the virtual storage space 32, according to an exemplary embodiment of the inventive concept.

Referring to FIGS. 1 and 2, the virtual storage space 32 may be formed of a plurality of strips S₁ through Sₘ. The number of strips is determined based on the capacity of the virtual storage space 32 and size of each of the segments, and the number of strips S1 through Sₘ shown in FIG. 2 is m, where m is a natural number. For example, if the storage capacity of the data storage devices 10-1 through 10-n is 128 GB (gigabytes) (in other words, 128*2³⁰ (binary)) and the size of each segment is a 512 B (bytes), which is the standard sector size, m may indicate 256M (mega), in other words, 256*2²⁰.

Each of the strips S₁ through Sₘ may be divided into segments of the same size. In other words, the first strip S₁ may be divided into N segments P₁ through Pₙ, and the second strip S₂ may be divided into N segments Pₙ₊₁ through P₂ₙ. In this regard, the m^{th} strip Sₘ may be divided into N segments P₍ₘ₋₁₎ₙ₊₁ through Pₘₙ.

All of the segments P₁ through Pₘₙ have the same size. For example, each of the segments P₁ through Pₘₙ may have the same size as the standard sector size of the data storage devices 10-1 through 10-n. For example, a size of each of the segments P₁ through Pₘₙ may be 512 B or 4 kB (kilobytes). However, the size of each of the segments P₁ through Pₘₙ is not limited to the standard sector size, and, if required, may be a size from about several kB to several MB (megabytes). The size of each of the segments P₁ through Pₘₙ may also be the same as the size of a block of data transmitted between the tester 40 and the data storage devices 10-1 through 10-n.

First segments P₁, Pₙ₊₁, . . . , and P₍ₘ₋₁₎ₙ₊₁ of each of the strips S₁ through Sₘ sequentially correspond to the storage space 12-1 of the first data storage device 10-1. Second segments P₂, Pₙ₊₂, . . . , and P₍ₘ₋₁₎ₙ₊₂ of each of the strips S₁ through Sₘ sequentially correspond to the storage space 12-2 of the second data storage device 10-2. In this regard, N^{th} segments Pₙ, P₂ₙ, . . . , and Pₘₙ of each of the strips S₁ through Sₘ sequentially correspond to a storage space 12-n of the N^{th} data storage device 10-n.

The relationship between the storage spaces 12-1 through 12-n and the virtual storage space 32 may be stored in the gender 20 as mapping information. The tester 40 may only have information regarding the virtual storage space 32 and issues commands based on virtual addresses of the virtual storage space 32. The gender 20 finds a data storage device and an actual address thereof corresponding to the virtual address by using the mapping information and performs a command issued by the tester 40 with respect to the actual address.

FIGS. 3A through 3C are diagrams for describing a sequential access test that may be performed by a tester, according to an exemplary embodiment of the inventive concept.

The sequential access test includes an operation of writing test data, wherein the size of the test data is the same as the size of the entire storage space of a data storage device, to the storage space and an operation of reading the test data therefrom. For example, a tester sequentially writes the test data from the first address of a data storage device to the last address of the data storage device. Furthermore, the tester sequentially reads the test data, which is written to the storage space of the data storage device, from the first address of the data storage device to the last address of the data storage device. Next, the read-out data is compared to the test data to determine whether the data storage device is normal. Therefore, if a tester performs sequential access tests with respect to a plurality of data storage devices, in the conventional fashion, a total period of time elapsed for the sequential access tests increases in proportion to the number of data storage devices to be tested.

According to an exemplary embodiment of the inventive concept, a testing sequence may include a sequential access test, but which is performed on a virtual storage space, thereby preventing the increase in test time associated with the conventional method.

As described above with reference to FIGS. 1 and 2, if the data storage devices 10-1 through 10-n are connected to the tester 40 via the gender 20, the tester 40 logically recognizes that the virtual data storage device 30 having the virtual storage space 32 is connected thereto.

Similar to the sequential access test performed on a data storage device, the tester 40 writes test data, wherein the size of the test data is the same as the size of the entire virtual storage space 32, to the virtual storage space 32.

As shown in FIG. 3A, the gender 20 divides the test data into data segments D₁ through Dₘₙ. All of the data segments D₁ through Dₘₙ have the same size, which is same as that of each of the segments P₁ through Pₘₙ of the virtual storage space 32.

As shown in FIG. 3B, the gender 20 writes the data segments D₁ through Dₘₙ to the storage spaces 12-1 through 12-n of the data storage devices 10-1 through 10-n in a round-robin fashion. Therefore, the data segments D₁, Dₙ₊₁, D₂ₙ₊₁, . . . , and D₍ₘ₋₁₎ₙ₊₁ are written to the storage space 12-1 of the first data storage device 10-1. In this regard, the data segments Dₙ, D₂ₙ, D₃ₙ, . . . , and Dₘₙ are written to the storage space 12-n of the N^{th} data storage device 10-n.

FIG. 3C is a timing diagram showing times at which the data segments D₁ through Dₘₙ are written to the storage spaces 12-1 through 12-n of the data storage devices 10-1 through 10-n.

Referring to FIG. 3C, since all of the data segments D₁ through Dₘₙ have the same size, a same period of time t₀ elapses for writing each of the data segments D₁ through Dₘₙ to the storage spaces 12-1 through 12-n of the data storage devices 10-1 through 10-n.

The data segment D₁ is written to the storage space 12-1 in a period of time between 0 and t₀. The data segment D₂ is written to the storage space 12-2 in a period of time between Δt and t₀+Δt. The data segment D₃ is written to the storage space 12-3 in a period of time between 2Δt and t₀+2Δt. In this regard, the data segment Dₙ is written to the storage space 12-n in a period of time between nΔt and t₀+nΔt. Furthermore, the data segment Dₙ₊₁ is written to the storage space 12-1 in a period of time between t₀ and 2t₀, following the data segment D₁. In this manner, the remaining data segments are written to the remaining storage spaces until the data segment Dₘₙ is written to the storage space 12-n.

As shown in FIG. 3C, the data segment D₂ starts to be written at the end of the period of time Δt after the data segment D₁ has begun to be written to the storage space 12-1. Δt is a period of time less than t₀ and may be a difference between the period of time that elapses between when the data segments D₁ and D₂ are transmitted from the tester 40 to the gender 20. Furthermore, Δt may be a difference of the period of time that elapses between when the data segments D₁ and D2 are processed in the gender 20. However, as described above, data input and output between the tester 40 and the data storage devices 10-1 through 10-n or data processing in the gender 20 is faster than writing/reading data to/from each of the data storage devices 10-1 through 10-n, and thus, Δt is significantly smaller than t₀. In the case where the data segments D₁ and D₂ are transmitted from the tester 40 to the gender 20 using a single block and the gender 20 processes the data segments D₁ and D₂ in parallel, Δt may be almost zero.

When performing a sequential access test on a physically single data storage device, only one data segment is written during a cycle t₀. However, in the case where the data storage devices 10-1 through 10-n are virtualized to the single virtual data storage device 30 according to an exemplary embodiment of the inventive concept, N data segments may be written to the corresponding data storage devices 10-1 through 10-n during the cycle t₀.

Furthermore, similar to the sequential access test performed on a data storage device, the tester 40 reads out test data written to the virtual storage space 32. As shown in FIG. 3B, of the test data written to the virtual storage space 32, the data segments D₁, Dₙ₊₁, D₂ₙ₊₁, . . . , and D₍ₘ₋₁₎ₙ₊₁ are written to the storage space 12-1 of the first data storage device 10-1. In this manner, the data segments Dₙ, D₂ₙ, D₃ₙ, . . . , and Dₘₙ are written to the storage space 12-n of the N^{th} data storage device 10-n.

The gender 20 reads out the data segments D₁ through Dₘₙ from the data storage devices 10-1 through 10-n and outputs the data segments D₁ through Dₘₙ to the tester 40.

The data segments D₁ through Dₘₙ are read out in a similar manner. The data segment D₁ is read out from the storage space 12-1 in a period of time between 0 and t₀. The data segment D₂ is read out from the storage space 12-2 in a period of time between Δt and t₀+Δt. In this regard, the data segment Dₙ is read out from the storage space 12-n in a period of time between nΔt and t₀+nΔt. Furthermore, the data segment Dₙ₊₁ is read out from the storage space 12-1 in a period of time between t₀ and 2t₀, following the data segment D₁.

When performing a sequential access test on a physically single data storage device, only one data segment may be written during a cycle t₀. However, in the case where the data storage devices 10-1 through 10-n are virtualized to the single virtual data storage device 30 according to an exemplary embodiment of the inventive concept, N data segments may be read out from the corresponding data storage devices 10-1 through 10-n during the cycle t₀.

The tester 40 may determine a defective data storage device of the data storage devices 10-1 through 10-n by comparing a read-out result with the test data.

Therefore, according to an exemplary embodiment of the inventive concept, N data storage devices 10-1 through 10-n may be tested in a period of time substantially same as or similar to a period of time for testing a physically single data storage device.

Hereinafter, a random access test that may be performed by a tester according to an exemplary embodiment of the inventive concept will be described.

The random access test includes an operation of randomly accessing a storage space of a data storage device. The access includes writing in and/or reading out test data of a predetermined size with respect to a randomly selected address. Since, conventionally, a plurality of accesses may not be simultaneously performed on a physically single data storage device, if a tester performs a random access test with respect to each of a plurality of data storage devices, a total period of time elapsed for the random access tests increases in proportion to the number of data storage devices to be tested.

According to an exemplary embodiment of the inventive concept, a testing sequence may include a random access test, but which is performed on a virtual storage space, thereby preventing the increase in test time associated with the conventional method. Hereinafter, an access for writing test data of a predetermined size to a randomly selected address will be described.

As described above with reference to FIGS. 1 and 2, if the data storage devices 10-1 through 10-n are connected to the tester 40 via the gender 20, the tester 40 logically recognizes that the virtual data storage device 30 having the virtual storage space 32 is connected thereto.

The tester 40 writes test data of a predetermined size with respect to randomly selected virtual addresses of the virtual storage device 30.

The randomly selected virtual addresses are likely to be dispersedly mapped to the storage spaces 12-1 through 12-n of the data storage devices 10-1 through 10-n. Therefore, while one piece of the test data may be written to a data storage device, another piece of the test data may be written to another data storage device. Therefore, by performing a random access test on the virtual data storage device 30, which virtualizes the data storage devices 10-1 through 10-n, the tester 40 may complete a random access test in a shorter period of time as compared to a period of time it takes for the tester 40 to perform random access tests on all of a plurality of data storage devices not virtualized.

To further reduce a period of time it takes for a random access test, virtual addresses may be selected by using a strip as a unit, as shown in FIG. 2. Here, a strip to which selected virtual addresses belong includes N segments, and the N segments are respectively mapped to the data storage devices 10-1 through 10-n. Therefore, an effect of performing random access tests on all of the data storage devices 10-1 through 10-n may be achieved by selecting virtual addresses by using a strip as a unit.

Alternatively, a size of each piece of test data may be set to be N times a size of each segment. In this case, logically writing the test data to the virtual storage space 32 is identical to logically dividing the test data into N segments and respectively writing the N segments to the data storage devices 10-1 through 10-n. Therefore, every time a virtual address is selected, a random access test is performed on all of the data storage devices 10-1 through 10-n.

Therefore, if virtual addresses are selected by using a strip as a unit or a size of each piece of test data is set to be N times a size of each segment according to an exemplary embodiment of the inventive concept, a random access test may be performed on N data storage devices 10-1 through 10-n in a period of time substantially the same as or similar to a period of time for performing a random access test on a physically single data storage device.

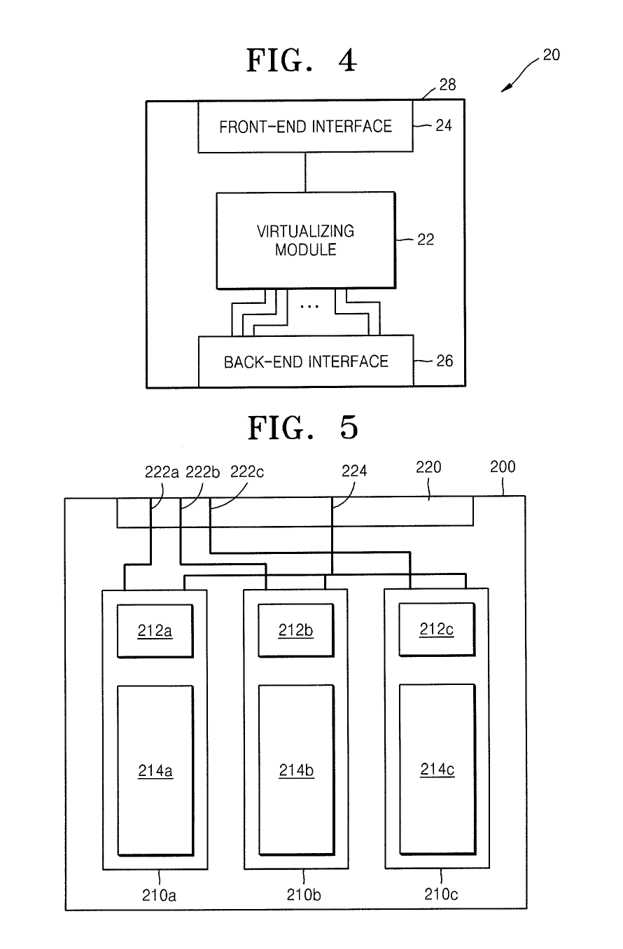

FIG. 4 is a view of the gender 20 according to an exemplary embodiment of the inventive concept.

Referring to FIG. 4, the gender 20 includes a virtualizing module 22, a front-end interface 24 connectable to the tester 40, and a back-end interface 26 connectable to the data storage devices 10-1 through 10-n.

The gender 20 is a unit for physically connecting the data storage devices 10-1 through 10-n to the tester 40. In the case where the data storage devices 10-1 through 10-n are connected to the tester 40 via the gender 20, the tester 40 recognizes the single virtual data storage device 30 having the single virtual storage space 32 as one physical device connected to the tester 40. Since the description of the gender 20 is provided above with reference to FIG. 1, a further detailed description thereof will be omitted.

The virtualizing module 22 virtualizes the storage spaces 12-1 through 12-n of the data storage devices 10-1 through 10-n to the single virtual storage space 32. The virtualizing module 22 may include a RAID controller chip. Furthermore, the virtualizing module 22 may cause the tester 40 to logically recognize the data storage devices 10-1 through 10-n as the single virtual data storage device 30 having the virtual storage space 32 via disk striping, in other words, RAID 0.

Furthermore, the virtualizing module 22 may unify input/output interfaces, so that the tester 40 and the data storage devices 10-1 through 10-n having different input/output interfaces may communicate with each other. For example, if the gender 20 is connected to the tester 40 via a USB interface and the gender 20 is connected to the data storage devices 10-1 through 10-n via a SATA interface, the gender 20 may convert data input and output via the USB interface to be compatible with the SATA interface, and thus, data may be input and output between the tester 40 and the data storage devices 10-1 through 10-n.

The front-end interface 24 enables data input and output between the tester 40 and the virtualizing module 22. The front-end interface 24 may be a standard interface, such as a SATA interface, an external SATA (e-SATA) interface, an E-IDE interface, an SCSI, a ZIF type interface, a CF type interface, a USB interface, an IEEE 1394 interface, or the like.

The back-end interface 26 enables data input and output between the data storage devices 10-1 through 10-n and the virtualizing module 22. The back-end interface 26 may be a standard interface, such as a SATA interface, an e-SATA interface, an E-IDE interface, an SCSI, a ZIF type interface, a CF type interface, a USB interface, an IEEE 1394 interface, or the like. Alternatively, the back-end interface 26 may be an exclusive interface defined by the manufacturer of the data storage devices 10-1 through 10-n. For example, the back-end interface 26 may be a serial attached SCSI (SAS) connector or a low-insertion force (LIF) connector, which is a physical combination of a data connector and a power connector.

The back-end interface 26 may include a plurality of connectors to which each of the data storage devices 10-1 through 10-n may be individually connected. Alternatively, the back-end interface 26 may include a single connector, which includes data pin sets and power pin sets.

The tester 40 may provide power to the virtualizing module 22 and the data storage devices 10-1 through 10-n, which are connected via the back-end interface 26. The gender 20 may further include a power regulator circuit for stabilizing the power.

The gender 20 may further include a controller board 28. The virtualizing module 22 may be formed on the controller board 28, and the front-end interface 24 and the back-end interface 26 may be formed at edges of the controller board 28. Furthermore, the controller board 28 may include wiring for electrically connecting the virtualizing module 22, the front-end interface 24, and the back-end interface 26 to each other. The controller board 28 may be a printed circuit board (PCB).

FIG. 5 is a diagram showing a multi SSD 200, which is one of the data storage devices that may be connected to the gender 20 according to an exemplary embodiment of the inventive concept.

Referring to FIG. 5, the multi SSD 200 includes a plurality of memory modules 210a, 210b, and 210c. Although the three memory modules 210a, 210b, and 210c are shown in FIG. 5, the inventive concept is not limited thereto. For example, more than three memory modules may be included in the multi SSD 200 or two memory modules may be included in the multi SSD 200. If the multi SSD 200 includes two memory modules, the multi SSD 200 may also be referred to as a dual SSD.

The memory modules 210a, 210b, and 210c may respectively include memory chips 214a, 214b, 214c and memory controllers 212a, 212b, and 212c for respectively controlling the memory chips 214a, 214b, and 214c. The memory modules 210a, 210b, and 210c may independently store digital data. In addition, the memory module 210a may include a plurality of the memory chips 214a, and a memory controller 212a for controlling the plurality of memory chips 214a. One of the memory modules 210a, 210b, and 210c may correspond to one of the data storage devices 10-1 through 10-n as shown in FIG. 1.

The multi SSD 200 may include one connector 220 connected to the memory modules 210a, 210b, and 210c. The connector 220 may include a data pin set 222a, a data pin set 222b, a data pin set 222c, and a power pin set 224. The data pin set 222a includes a plurality of data pins for independently inputting data to and outputting data from the memory module 210a. The data pin set 222b includes a plurality of data pins for independently inputting data to and outputting data from the memory module 210b. The data pin set 222c includes a plurality of data pins for independently inputting data to and outputting data from the memory module 210c. The power pin set 224 includes a plurality of power pins for supplying power to the memory modules 210a, 210b, and 210c.

Each of the data pin sets 222a, 222b, and 222c may include four pins. In this case, the four pins may correspond to RX+, RX−, TX+, and TX−, respectively. The power pin set 224 may include at least two pins. In this case, the at least two pins may include at least one pin, to which VCC is applied, and at least one pin, to which GND is applied. Here, VCC may be 3.3V. The connector 220 may be a LIF-type connector.

According to an exemplary embodiment of the inventive concept, the multi SSD 200 may include a plurality of data connectors (not shown) for inputting data to and outputting data from the memory modules 210a, 210b, and 210c and one power connector (not shown) for supplying power to the memory modules 210a, 210b, and 210c.

Conventionally, a test is performed on each of the memory modules 210a, 210b, and 210c, one at a time, to test the multi SSD 200. However, according to an exemplary embodiment of the inventive concept, the memory modules 210a, 210b, and 210c may be simultaneously tested by using the gender 20 as shown in FIG. 4.

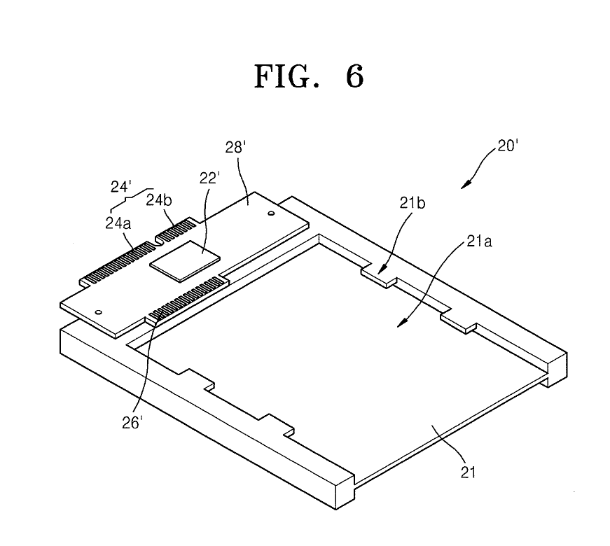

FIG. 6 is a perspective view of a gender 20′ according to an exemplary embodiment of the inventive concept, which may be connected to the multi SSD 200 shown in FIG. 5.

Referring to FIGS. 5 and 6, the gender 20′ includes a RAID controller 22′, a front-end interface 24′, and a back-end interface 26′. Furthermore, the gender 20′ may include a controller board 28′ and a supporting base 21.

The RAID controller 22′ is connectable to the memory modules 210a, 210b, and 210c, and may be a RAID controller chip for causing the memory modules 210a, 210b, and 210c to be recognized as a single virtual data storage device. The RAID controller 22′ may correspond to the virtualizing module 22 shown in FIG. 4.

The multi SSD 200 may be connected to the back-end interface 26′, and the back-end interface 26′ may connect the memory modules 210a, 210b, and 210c to the RAID controller 22′. The back-end interface 26′ may correspond to the back-end interface 26 shown in FIG. 4.

As shown in FIG. 6, the back-end interface 26′ may be a single connector including a plurality of data pin sets for independently inputting data to and outputting data from the memory modules 210a, 210b, and 210c and a power pin set for supplying power to the memory modules 210a, 210b, and 210c. For example, the back-end interface 26′ may be a LIF-type plug connector.

According to an exemplary embodiment of the inventive concept, the back-end interface 26′ may include a plurality of corresponding data connectors (not shown) and a single corresponding power connector (not shown) to be physically connected to a multi SDD including a plurality of data connectors (not shown) for inputting data to and outputting data from the memory modules 210a, 210b, and 210c and a power connector (not shown) for supplying power to the memory modules 210a, 210b, and 210c.

The tester 40 may be connected to the front-end interface 24′, and the front-end interface 24′ may connect the tester 40 to the RAID controller 22′. The front-end interface 24′ may correspond to the front-end interface 24 shown in FIG. 4. As shown in FIG. 6, the front-end interface 24′ may be a SATA interface and may include a SATA data plug connector 24b and a SATA power plug connector 24a.

The RAID controller 22′ may be mounted on the controller board 28′, and wiring for electrically connecting the RAID controller 22′ to the back-end interface 26′ and the front-end interface 24′ may be formed on the controller board 28′. The controller board 28′ may correspond to the controller board 28 shown in FIG. 4. The front-end interface 24′ and the back-end interface 26′ may be formed at two opposite sides of the controller board 28′, respectively. For example, the controller board 28′ may be a PCB.

The controller board 28′ may be attached to the supporting base 21, and the supporting base 21 may fix the multi SSD 200. A groove 21a, to which the multi SSD 200 may be inserted, may be formed in the supporting base 21, and the supporting base 21 may include a guide 21b by which the multi SSD 200 may be slide-inserted in parallel to the supporting base 21. The multi SSD 200 may be detachably attached to the gender 20′ via the supporting base 21.

By using the gender 20′, a worker may conveniently and simultaneously connect the memory modules 210a, 210b, and 210c to the tester 40 instead of connecting each of the memory modules 210a, 210b, and 210c to the tester 40 one at a time. Furthermore, the worker is prevented from mistakenly omitting tests with respect to the memory modules 210a, 210b, and 210c.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A method of testing data storage devices, the method comprising:
virtualizing data storage spaces of N data storage devices to a single virtual storage space, wherein N is a natural number equal to or greater than two; and
testing the N data storage devices by performing a testing sequence on the virtual storage space.

2. The method of claim 1, wherein the N data storage devices are configured as a redundant array of independent disks (RAID) to be recognized by a tester, which performs the testing sequence, as a single virtual data storage device having the virtual storage space.

3. The method of claim 1, wherein the N data storage devices are configured to be recognized by a tester, which performs the testing sequence, as a single virtual data storage device having the virtual storage space by using disk striping.

4. The method of claim 1, wherein the virtual storage space comprises a plurality of strips,
each of the plurality of strips comprises N segments, and
the N segments of each of the plurality of strips are each mapped to a respective one of the data storage spaces of the N data storage devices.

5. The method of claim 1, wherein the testing sequence comprises a sequential access test performed on the virtual storage space, and
during the sequential access test, logically continuous test data is divided into data segments of a first size and the data segments are written to the N data storage devices in a round-robin fashion.

6. The method of claim 5, wherein the data segments comprise a first data segment and a second data segment, which are logically continuous with each other, and
while the first data segment is written to one of the N data storage devices, the second data segment is written to another one of the N data storage devices.

7. The method of claim 5, wherein first and second periods of time for respectively writing logically continuous first and second data segments of the data segments to the N data storage devices in a round-robin fashion partially overlap each other.

8. The method of claim 1, wherein the testing sequence comprises a random access test performed on the virtual storage space.

9. The method of claim 1, wherein at least one of the N data storage devices includes a solid state drive (SSD).

10. The method of claim 1, wherein at least one of the N data storage devices includes a plurality of memory modules included in a multi SSD.

11. The method of claim 10, wherein at least one of the plurality of memory modules comprises:
at least one memory chip; and
a memory controller for controlling the at least one memory chip.

12. The method of claim 10, wherein the multi SSD comprises a connector, wherein the connector comprises:
a plurality of data pin sets, each of the data pin sets for independently inputting data to and outputting data from one of the plurality of memory modules; and
a power pin set for supplying power to the plurality of memory modules.

13. The method of claim 1, wherein the testing sequence is performed simultaneously on at least two of the N data storage devices.

14. An apparatus for testing data storage devices, the apparatus comprising:
a first interface for connecting the apparatus to N data storage devices, wherein N is a natural number equal to or greater than two and each of the N data storage devices includes a data storage space;
a module connected to the first interface, the module for virtualizing the data storage spaces of the N data storage devices to a single virtual storage space; and
a second interface connected to the module, the second interface for connecting to a tester that tests the N data storage devices by performing a testing sequence on the virtual storage space.

15. The apparatus of claim 14, wherein the module includes a redundant array of independent disks (RAID) controller.

16. An apparatus for testing a first memory module having at least one first memory chip and a first memory controller for controlling the at least one first memory chip and a second memory module having at least one second memory chip and a second memory controller for controlling the at least one second memory chip, the apparatus comprising:
a redundant array of independent disks (RAID) controller that configures the first memory module and the second memory module as a RAID to be recognized as a single virtual data storage device by a tester;
a back-end interface, to which the first memory module and the second memory module are connected and through which the first memory module and the second memory module are connected to the RAID controller; and
a front-end interface, to which the tester is connected and though which the tester is connected to the RAID controller.

17. The apparatus of claim 16, wherein the back-end interface is a low-insertion force (LIF) type connector comprising:
a first data pin set for inputting data to and outputting data from the first memory module;
a second data pin set for inputting data to and outputting data from the second memory module; and
a power pin set for supplying power to the first and second memory modules.

18. The apparatus of claim 16, wherein the front-end interface is a serial advanced technology attachment (SATA) interface.

19. The apparatus of claim 16, wherein the first memory module and the second memory module are included in a solid state drive (SSD).

20. The apparatus of claim 19, further comprising:
a controller board including the RAID controller, the front-end interface and the back-end interface, wherein the controller board includes wiring for electrically connecting the RAID controller to the front-end interface and the back-end interface; and
a supporting base to which the controller board is attached and the SSD is detachably mounted.
